(19) United States
(12) Patent Application Publication
(10) Pub. No.: US 2018/0152946 A1
(43) Pub. Date: May 31, 2018

(54) CHANNEL SELECTION DEVICE AND CHANNEL SELECTION METHOD

(71) Applicant: INSTITUTE FOR INFORMATION INDUSTRY, Taipei (TW)

(72) Inventors: Jui-Yuan CHANG, Taipei City (TW); Chih-Chiang WU, Taichung City (TW)

(21) Appl. No.: 15/368,664

(22) Filed: Dec. 4, 2016

(30) Foreign Application Priority Data
Nov. 28, 2016 (TW) 105139099

(51) Int. Cl. H04W 72/08; H04W 72/04; H04W 16/14; H04L 5/00

(52) U.S. Cl. CPC H04W 72/082; H04W 72/0446; H04L 5/0062; H04W 72/0453; H04W 16/14; H04W 72/085

(57) ABSTRACT

A channel selection device includes a transmission unit, a database and a processor. The transmission unit receives a first communication data. The database stores a history data. The history data includes a second communication data and a third communication data. The processor calculates a statistical data, a channel changing data and a time duration data. The statistical data is corresponding to a first ratio, the channel changing data is corresponding to a second ratio, and the time duration data is corresponding to a third ratio. The processor generates a predict channel information according to the statistical data, the channel changing data and the time duration data.

### RELATED APPLICATIONS

This application claims priority to Taiwan Application Serial Number 105139099, filed Nov. 28, 2016, which is herein incorporated by reference.

### BACKGROUND

### Technical Field

The present disclosure relates to a channel selection device and a channel selection method. More particularly, the present disclosure relates to a channel selection device and a channel selection method using the unlicensed frequency band.

### Description of Related Art

In general, a wireless communication system (e.g., the LTE system) runs in a specific RF (Radio frequency) frequency band, and a channel selection device (e.g., a mobile phone) is able to communicate with a base station through the specific RF frequency band. The wireless telecom operators have to apply for or buy the license from the government, so as to obtain the usage right of this specific RF frequency band.

In an entire transmission spectrum, some frequency bands belong to the unlicensed frequency bands, e.g., some frequency bands that the government retains. When anyone intends to use the unlicensed frequency bands, he/she does not have to buy or apply for the license from the government. Therefore, plural of wireless and mobile telecom vendors (e.g., the Wi-Fi equipment vendor, the Bluetooth equipment vendor, or the LTE equipment vendor) will use these unlicensed frequency bands in order to obtain more transmission bandwidth. For example, the LTE communication system establishes licensed-assisted access (LAA) protocol, enhanced licensed-assisted access (eLAA) protocol, and so on, which are used for standardizing the operations of the unlicensed frequency band in the LTE communication system.

However, in the process of using the unlicensed frequency band, one device with one wireless communication system (e.g., the LTE communication system) has to coexist harmonically with other devices (e.g., the Wi-Fi communication system) that are not controlled by its wireless communication system. For example, when the LTE communication system intends to use an unlicensed frequency band or a shared frequency band for wireless communication, other communication devices with the same or different wireless access technique may intend to use the same unlicensed or shared frequency band. It can be seen that plural of devices may compete or interfere with each other when they share the unlicensed band.

Therefore, how to provide a channel selection device which is able to efficiently find the channel having better communication quality in the unlicensed bands becomes a problem.

### SUMMARY

To address the issues, one aspect of the present disclosure is to provide a channel selection device including a transmission unit, a database, and a processor. The transmission unit is configured for receiving a first communication data. The database is configured for storing a history data, in which the history data includes a second communication data and a third communication data. The processor is configured for calculating a statistical data, a channel changing data, and a time duration data according to the history data, and generating a predicted channel information according to the statistical data, the channel changing data, and the time duration data, in which the statistical data is corresponding to a first ratio, the channel changing data is corresponding to a second ratio, and the time duration data is corresponding to a third ratio. The processor compares the first communication data with the predicted channel information, and adjusts the first ratio, the second ratio, and the third ratio according to a comparison result, so as to update the predicted channel information.

Another aspect of the present disclosure is to provide a channel selection method including: receiving a first communication data; storing a history data, in which the history data includes a second communication data and a third communication data; calculating a statistical data, a channel changing data, and a time duration data according to the history data, and generating a predicted channel information according to the statistical data, the channel changing data, and the time duration data, in which the statistical data is corresponding to a first ratio, the channel changing data is corresponding to a second ratio, and the time duration data is corresponding to a third ratio; comparing the first communication data with the predicted channel information, and adjusting the first ratio, the second ratio, and the third ratio according to a comparison result, so as to update the predicted channel information.

By the aforementioned channel selection device and channel selection methods, it is able to predict the communication state of the unlicensed frequency band and efficiently find the frequency band with better communication quality in the unlicensed frequency band by adjusting the ratios of plural of prediction methods when multiple mobile devices share the unlicensed band. Accordingly, the base station is able to appoint the mobile devices to transmit the data through the frequency band having better transmission ability, and avoid the condition that the mobile devices compete or interfere with each other while transmitting.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 depicts a schematic diagram of a transmission system according to one embodiment of present disclosure;

FIG. 2 depicts a block diagram of a channel selection device according to one embodiment of the present disclosure;

FIG. 3 depicts a schematic diagram of a transmission system according to one embodiment of the present disclosure;

FIG. 4 depicts a flow chart of a channel selection method according to one embodiment of the present disclosure;

FIG. 5 depicts a schematic diagram of a statistical data according to one embodiment of the present disclosure;

FIG. 6A and FIG. 6B depict schematic diagrams of a channel changing data according to one embodiment of the present disclosure; and

FIG. 7 depicts a schematic diagram of a time duration data according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

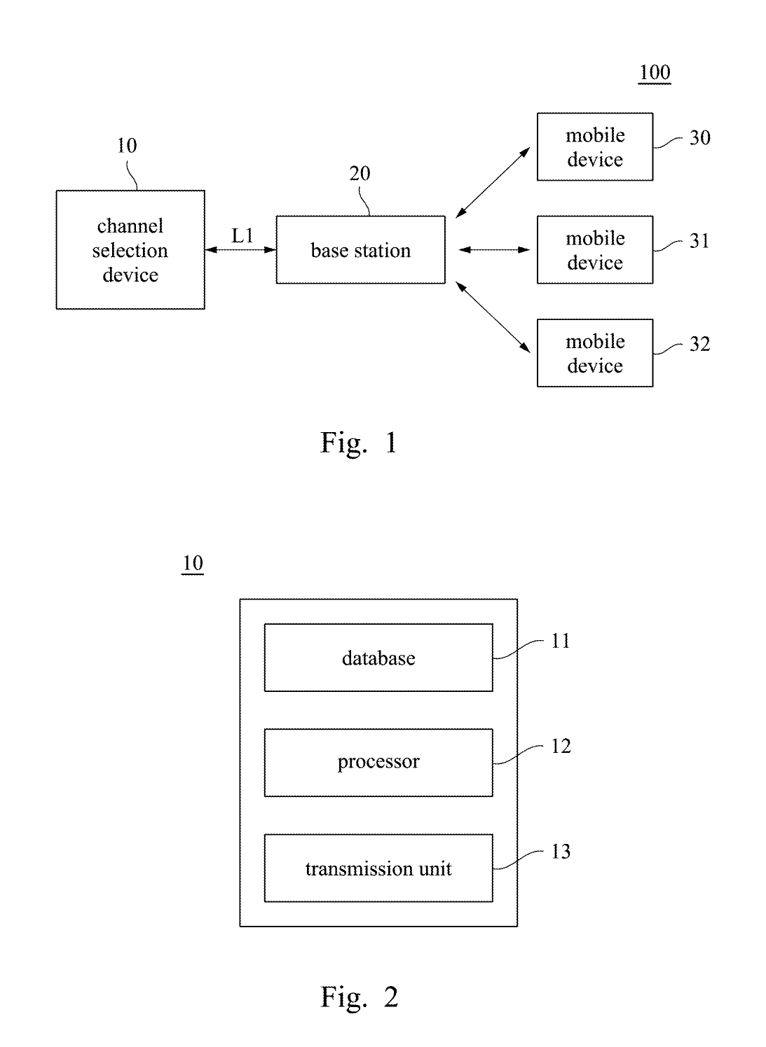

Reference is made to FIG. 1. FIG. 1 depicts a schematic diagram of a transmission system 100 according to one embodiment of present disclosure. In one embodiment, the transmission system 100 includes a channel selection device 10 and a base station 20. In one embodiment, the channel selection device 10 is able to establish a communication link L1 with the base station 20. In one embodiment, the base station 20 may be the LTE base station. In one embodiment, the transmission system 100 includes mobile devices 30, 31, and 32. Each of the mobile devices 30-32 can be, for example, a tablet, a notebook, a smart phone or other electronic devices with the transmission function.

In one embodiment, the mobile devices 30-32 are able to communicate with the base station 20, respectively. The mobile devices 30-32 transmit the communication data detected by themselves to the base station 20, respectively. The communication data include the position information, the signal strength, the communication protocol (e.g., the Wi-Fi protocol, the Bluetooth protocol, the Zigbee protocol, etc.), the type of the signal (e.g., the Wi-Fi signal, the Bluetooth signal, the Zigbee signal, the television signal, the wireless keyboard and/or the microphone signal), the transmission channel and/or the transmission bandwidth. Accordingly, the base station 20 uses for collecting and sorting the various communication data received, and transmitting the communication data to the channel selection device 10 for analyzing. The base station 20 appoints a better (more stable or higher transmission quality) communication frequency band to the mobile devices 30-32 according to the analysis result. In one embodiment, the base station 20 is able to detect the communication data by itself, too.

Reference is made to FIG. 2. FIG. 2 depicts a block diagram of a channel selection device 10 according to one embodiment of the present disclosure. The channel selection device 10 includes a database 11, a processor 12, and a transmission unit 13. In one embodiment, the database 11 can be stored in a storage device. The storage device can be implemented by using a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains. In one embodiment, the processor 12 can be implemented by using a microcontroller, a microprocessor, a digital signal processor, an application specific integrated circuit (ASIC), or a logic circuit. In one embodiment, the transmission unit 13 is configured for establishing the communication link L1 with the base station 20. For example, the transmission unit 13 is the 2G, 3G, or 4G wireless network communication circuit, the Wi-Fi wireless communication circuit, the Bluetooth wireless communication circuit, the LTE wireless communication circuit, the Ethernet wireless communication circuit, other equivalent wireless communication circuit, or any combination thereof.

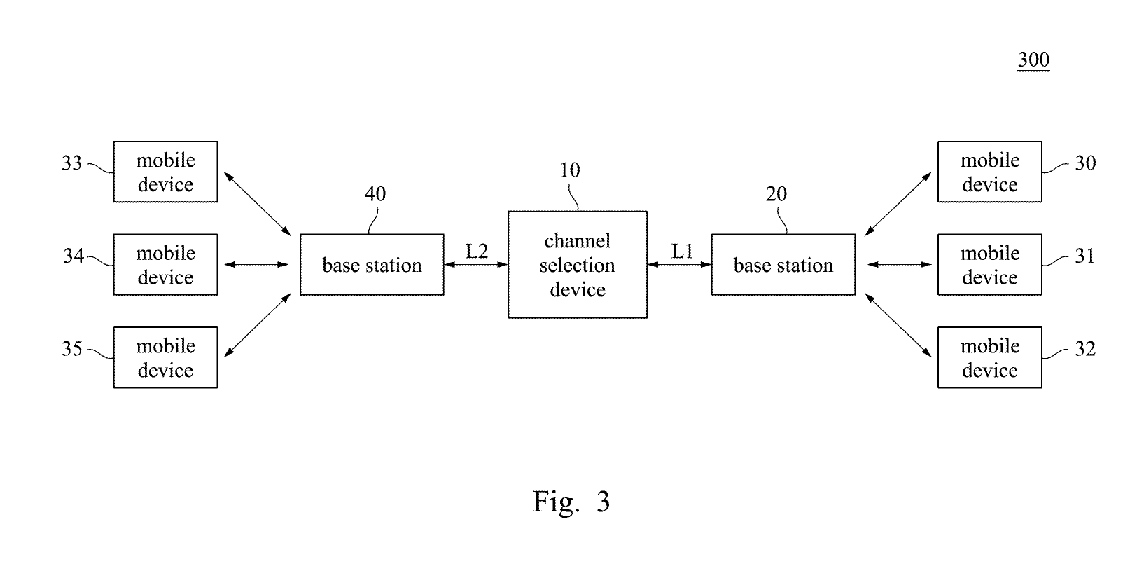

Reference is made to FIG. 3. FIG. 3 depicts a schematic diagram of a transmission system 300 according to one embodiment of the present disclosure. The difference between the transmission system 300 in FIG. 3 and the transmission system 100 in FIG. 1 is that the transmission system 300 further includes another base station 40. The base station 40 can be a Wi-Fi base station. The base station 40 is able to communicate with mobile devices 33, 34, and 35. The mobile devices 33-35 transmit the communication data detected by themselves to the base station 40, respectively. And, the channel selection device 10 is able to establish a communication link L2 with the base station 40. Accordingly, the Wi-Fi base station 40 can collect and sort the various communication data received by itself, and transmits the communication data to the channel selection device 10 for analyzing. The Wi-Fi base station 40 is able to appoint a better (more stable or higher transmission quality) communication frequency band to the mobile devices 33-35 according to the analysis result.

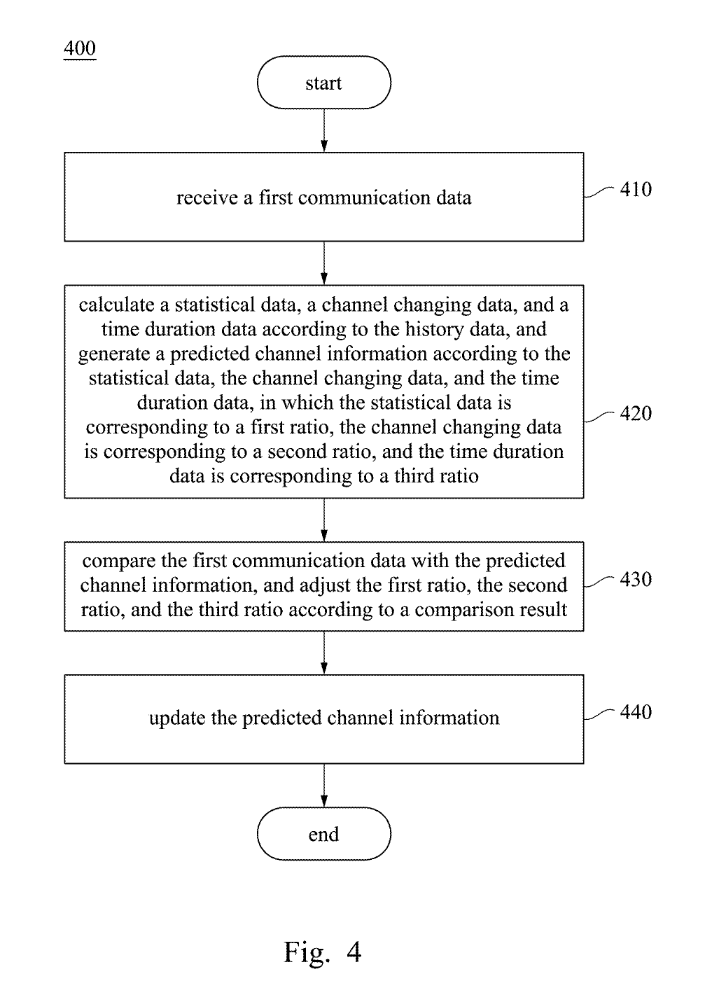

Reference is made to FIG. 4. FIG. 4 depicts a flow chart of a channel selection method 400 according to one embodiment of the present disclosure.

In operation 410, the transmission unit 13 is configured for receiving a first communication data. In one embodiment, the base station 20 collects and sorts the communication messages sent from the mobile devices 30-32 to obtain the first communication data, and transmits the first communication data to the transmission unit 13. For example, the base station 20 transmits the first communication data to the transmission unit 13 at a.m. 11:00.

In one embodiment, the database 11 is configured for storing the first communication data. Moreover, the database 11 is further configured for storing a history data, in which the history data includes a second communication data and a third communication data. The history data can include various communication data received before the current time point. For example, the second communication data can be the data received by the transmission unit 13 at a.m. 10:00, and the third communication data can be the data received by the transmission unit 13 at a.m. 9:00.

In one embodiment, the transmission unit 13 is able to receive at least one communication state of at least one unlicensed frequency band detected by the base station 20 or the mobile devices 30-32, such that the channel selection device 10 obtains the first communication data, the second communication data, and the third communication data.

In operation 420, the processor 12 is configured for calculating a statistical data, a channel changing data, and a time duration data according to the history data, and generating a predicted channel information according to the statistical data, the channel changing data, and the time duration data, in which the statistical data is corresponding to a first ratio, the channel changing data is corresponding to a second ratio, and the time duration data is corresponding to a third ratio.

In one embodiment, the first ratio is predetermined as 20 percent, the second ratio is predetermined as 35 percent, and the third ratio is predetermined as 45 percent. In other words, the predicted channel information can be obtained by calculating the 20 percent by weight of the statistical data, the 35 percent by weight of the channel changing data, and the 45 percent by weight of the time duration data. However, one of ordinary skill in the art should realize that the ratio (weight) herein is an exemplary embodiment, and it may be different in accordance with the actual operation environment. In one embodiment, the predicted channel information can be applied for predicting the communication state of one unlicensed frequency band.

The calculation of the statistical data, the channel changing data, and the time duration data are illustrated in detail below.

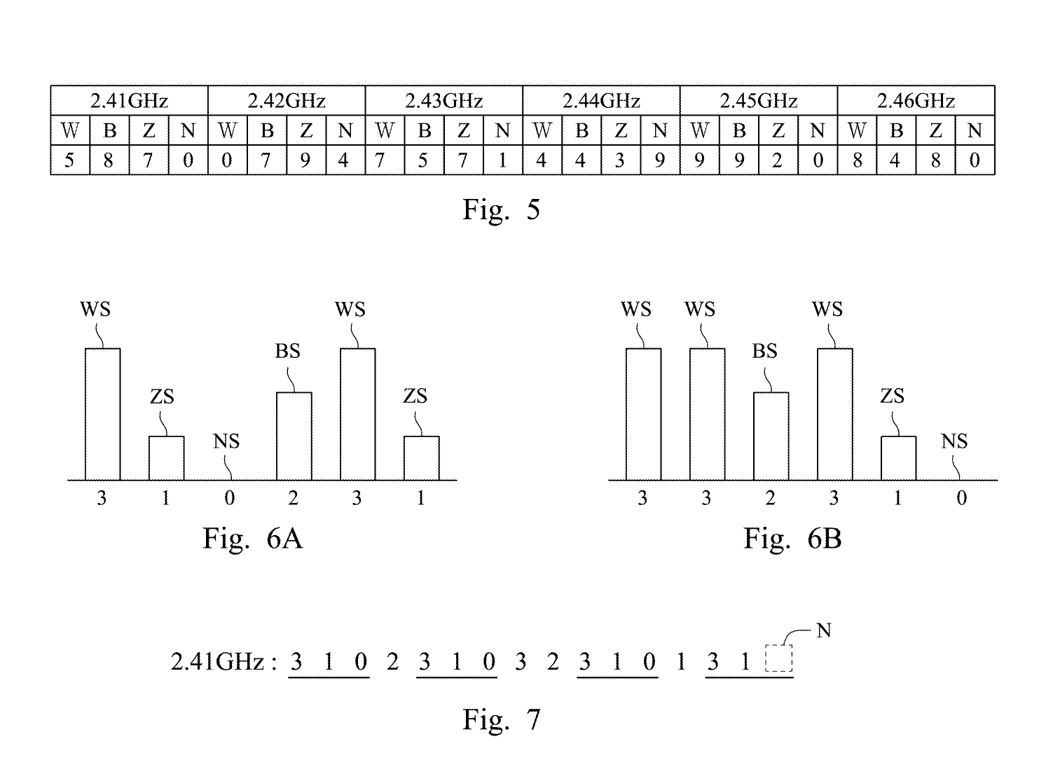

Reference is made to FIG. 5. FIG. 5 depicts a schematic diagram of a statistical data according to one embodiment of the present disclosure. In one embodiment, the processor 12 is configured for calculating the numbers of a time unit of multiple signals (e.g., the Wi-Fi signal, the Bluetooth signal, the Zigbee signal, etc.), which is transmitted by the transmission unit 13 through at least one unlicensed frequency band (e.g., 2.41 GHz, 2.42 GHz, 2.43 GHz, 2.44 GHz, 2.45 GHz, or 2.46 GHz), during a time period (e.g., 1 second).

As shown in FIG. 5, the character “W” represents the Wi-Fi signal, the character “B” represents the Bluetooth signal, the character “Z” represents the Zigbee signal, and the character “N” represents that the noise is unreceived. In one embodiment, the database 11 stores the number of the time unit(s) corresponding to each one of the different protocols when the transmission unit 13 transmits the data through each unlicensed frequency band. In other words, the processor 12 is configured for calculating the number of the time unit(s) in which a specific signal is transmitted through the unlicensed frequency band. For example, the Wi-Fi signal is transmitted in 5 time units through the unlicensed frequency band 2.41 GHz, the Bluetooth signal is transmitted in 8 time units through the unlicensed frequency band 2.41 GHz, the Zigbee signal is transmitted in 7 time units through the unlicensed frequency band 2.41 GHz, and the noise is unreceived in 0 time unit. By calculating these history data, it is applicable for predicting the transmission condition in the future.

FIG. 6A and FIG. 6B depict schematic diagrams of a channel changing data according to one embodiment of the present disclosure. In one embodiment, FIG. 6A and FIG. 6B depict the communication data transmitted in the same unlicensed frequency band (e.g., 2.41 GHz), in which FIG. 6A depicts the second communication data and the third communication data which are transmitted during a prior time slot, and FIG. 6B depicts the signal strength data during a current time slot which is predicted according to the second communication data and the third communication data. In this example, the channel changing data includes this signal strength data.

In one embodiment, as shown in FIG. 6A, the communication data WS represents the signal strength of the Wi-Fi signal, the communication data ZS represents the signal strength of the Zigbee signal, the communication data NS represents that the signal strength of the unreceived noise, and the communication data BS represents the signal strength of the Bluetooth signal. The communication data WS, ZS, NS, BS are transmitted through the unlicensed frequency band 2.41 GHz during the prior time slot. The processor 12 is able to predict a signal strength data (as shown in FIG. 6B) according to the respective signal strength of the communication data WS, ZS, NS, and BS.

In other words, the signal strength data during the current time slot is obtained by calculating the at least one signal strength during at least one prior time slot. For example, when the signal strength of the Wi-Fi signal during the prior time slot is 3, the signal strength of the Zigbee signal during the prior time slot is 1, the signal strength of the unreceived noise during the prior time slot is 0, and the signal strength of the Bluetooth signal during the prior time slot is 2 (as shown in FIG. 6A), it is able to predict that the signal strength of the Wi-Fi signal received during the current time slot may be 3, the signal strength of the Zigbee signal received during the current time slot may be 1, the signal strength of the unreceived noise received during the current time slot may be 0, and the signal strength of the Bluetooth signal received during the current time slot may be 2 (as shown in FIG. 6B).

In one embodiment, the database 11 is able to store the history data of plural of time slots sequentially. Therefore, the processor 12 is able to refer to the history data during plural of prior time slots (e.g., the first time slot to sixth time slot, in which the history data during the sixth time slot is illustrated in FIG. 6A, similarly, the history data during the first time slot to fifth time slot also include the signal strength data corresponding to various communication data, and thus no further detail will be given hereinafter) to predict the signal strength data during the current time slot (e.g., the current time slot is the seventh time slot illustrated in FIG. 6B).

Reference is made to FIG. 7. FIG. 7 depicts a schematic diagram of a time duration data according to one embodiment of the present disclosure. In one embodiment, the transmission unit 13 sequentially receives multiple signal strength data through the same frequency band (e.g., 2.41 GHz). The processor 12 is able to predict a channel occupation data according to at least one overlapping portion among these signal strength data. In this embodiment, the time duration data includes the channel occupation data. For example, as shown in FIG. 7, the processor 12 is able to determine that the signal strength data include plural of series of “3”, “1”, and “0” data and regard this series as the overlapping portion. Since a series of transmission signal may have regular competition, the processor 12 is able to predict that an N-th signal strength data is “0” when the two signal strength data prior to the N-th signal strength data are “3” and “1”.

In one embodiment, in accordance with the history data, the processor 12 is able to determine that the frequency band may not receive the noise when the signal strength data is predicted as “0”. Therefore, by using the characteristics of the timing sequence and the repetition of the signal strength data, it is able to predict whether the frequency band will be occupied.

In operation 430, the processor 12 compares the first communication data with the predicted channel information, and adjusts the first ratio, the second ratio, and the third ratio according to the comparison result. In one embodiment, the first communication data is the communication data which is received currently, and it is used for comparing with the predicted channel information so that the processor 12 is able to determine the accuracy of the predicted channel information and to adjust the ratios of the statistical data, the channel changing data, and the time duration data according to the comparison result. For example, the predicted channel information is adjusted as by calculating 20 percent by weight of the statistical data, 80 percent by weight of the channel changing data, and 0 percent by weight of the time duration data.

In one embodiment, it is able to understand the statistical data, the channel changing data, and the time duration data as a prediction method, respectively. It may be difficult for these prediction methods to perform the prediction when the history data is insufficient. Therefore, by adjusting the ratios (weights) of these prediction methods and decreasing the ratio of the prediction method which predicts unsuccessfully, the predicted channel information is able to be calculated with higher accuracy.

In one embodiment, the processor 12 sorts the statistical data, the channel changing data, and the time duration data from greatest ratio to least ratio, and sequentially determines whether these data can be used for performing the prediction. For example, it is supposed that the first ratio corresponding to the statistical data is 20 percent, the second ratio corresponding to the channel changing data is 35 percent, and the third ratio corresponding to the time duration data is 45 percent. In accordance with these ratios, the sequence in which the processor 12 sorts these prediction methods from greatest to least is: the time duration data, the channel changing data, and the statistical data. Then, the processor 12 determines whether the time duration data is predictable. If the time duration data is predictable, the processor 12 determines whether the channel changing data is predictable afterwards. If the time duration data is unpredictable, the processor 12 adds the value of the third ratio (45%) corresponding to the time duration data to the value of the second ratio (i.e., the secondary higher ratio) corresponding to the channel changing data, and updates the value of the third ratio to zero. As a result, each ratio is adjusted as: the first ratio is 20 percent, the second ratio is 80 percent, and the third ratio is 0 percent.

In other words, when the third ratio is greater than the first ratio and the second ratio, the second ratio is greater than the first ratio, and the processor 12 determines that the channel occupation data is unpredictable, the processor 12 adds the value of the third ratio to the value of the second ratio, and updates the value of third ratio to zero. That is, it is supposed that the first ratio is 20 percent, the second ratio is 35 percent, and the third ratio is 45 percent. And, if the prediction method with the greatest ratio is unable to calculate the effective prediction data (e.g., the time duration data corresponding to the third ratio is unpredictable), the value of this ratio (e.g., the third ratio: 45 percent) is added to the secondary higher ratio (e.g., the second ratio: 35 percent), such that each ratio is adjusted as: the first ratio is 20 percent, the second ratio is 80 percent, and the third ratio is 0 percent.

In one embodiment, the processor 12 sorts the statistical data, the channel changing data, and the time duration data from greatest ratio to least ratio, and determines that the second ratio is greater than the first ratio and the third ratio, and the first ratio is greater than the third ratio. If the processor 12 determines that the signal strength data is unpredictable, the processor 12 adds the value of the second ratio to the value of the first ratio and updates the value of the second ratio to zero. For example, it is supposed that the first ratio is 30 percent, the second ratio is 50 percent, and the third ratio is 20 percent. If the prediction method with the greatest ratio is unable to calculate the effective prediction data (e.g., the signal strength data corresponding to the second ratio is unpredictable), the value of this ratio (e.g., the second ratio: 50 percent) is added to the secondary higher ratio (e.g., the first ratio: 30 percent), such that each ratio is adjusted as: the first ratio is 80 percent, the second ratio is 0 percent, and the third ratio is 20 percent.

In operation 440, the processor 12 is further configured for updating the predicted channel information. In one embodiment, the processor 12 generates new predicted channel information according to the adjusted ratios of the statistical data, the channel changing data and the time duration data, and transmits this new predicted channel information to the base station 20. The base station 20 is able to appoint a better (more stable or higher transmission quality) communication frequency band to the mobile devices 30-32. For example, this new predicted channel information indicates that the frequency band 2.41 GHz will not be occupied by other signals. And, the base station 20 is able to appoint the mobile device 30 to transmit the data through the frequency band 2.41 GHz.

By the aforementioned channel selection device and channel selection methods, it is able to predict the communication state of the unlicensed frequency band and efficiently find the frequency band with better communication quality in the unlicensed frequency band by adjusting the ratios of multiple prediction methods when plural of mobile devices share the unlicensed band. Accordingly, the base station is able to appoint the mobile devices to transmit the data through the frequency band with better transmission ability, and avoid the condition that the mobile devices compete or interfere with each other while transmitting.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A channel selection device, comprising:
a transmission unit configured for receiving a first communication data;
a database configured for storing a history data, the history data comprising a second communication data and a third communication data;
a processor configured for calculating a statistical data, a channel changing data, and a time duration data according to the history data, and generating a predicted channel information according to the statistical data, the channel changing data, and the time duration data, wherein the statistical data is corresponding to a first ratio, the channel changing data is corresponding to a second ratio, and the time duration data is corresponding to a third ratio,
wherein the processor compares the first communication data with the predicted channel information, and adjusts the first ratio, the second ratio, and the third ratio according to a comparison result, so as to update the predicted channel information.

2. The channel selection device of claim 1, wherein the transmission unit receives at least one communication state of at least one unlicensed frequency band detected by a base station or a mobile device, such that the channel selection device obtains the first communication data, the second communication data, and the third communication data.

3. The channel selection device of claim 1, wherein the processor is configured for calculating a number of at least one time unit in which a specific signal is transmitted through at least one unlicensed frequency band during a time period.

4. The channel selection device of claim 1, wherein the second communication data and the third communication data are transmitted through an unlicensed frequency band at the same time point, wherein the second communication data and the third communication data comprise a first signal strength of a first signal and a second signal strength of a second signal, respectively, and the processor predicts a signal strength data according to the first signal strength and the second signal strength,
wherein the channel changing data comprises the signal strength data.

5. The channel selection device of claim 1, wherein the transmission unit receives a plurality of signal strength data sequentially, and the processor predicts a channel occupation data according to at least one overlapping portion among the signal strength data,
wherein the time duration data comprises the channel occupation data.

6. The channel selection device of claim 5, wherein when the third ratio is greater than the first ratio and the second ratio, the second ratio is greater than the first ratio, and the processor determines that the channel occupation data is unpredictable, the processor adds the value of the third ratio to the value of the second ratio and updates the value of the third ratio to zero.

7. The channel selection device of claim 4, wherein when the second ratio is greater than the first ratio and the third ratio, the first ratio is greater than the third ratio, and the processor determines that the signal strength data is unpredictable, the processor adds value of the second ratio to the value of the first ratio and updates the value of the second ratio to zero.

8. The channel selection device of claim 1, wherein the transmission unit establishes a communication link with the base station according to the predicted channel information after updating the predicted channel information.

9. A channel selection method, comprising:
receiving a first communication data;
storing a history data, the history data comprising a second communication data and a third communication data; and
calculating a statistical data, a channel changing data, and a time duration data according to the history data, and generating a predicted channel information according to the statistical data, the channel changing data, and the time duration data, wherein the statistical data is corresponding to a first ratio, the channel changing data is corresponding to a second ratio, and the time duration data is corresponding to a third ratio,
comparing the first communication data with the predicted channel information, and adjusting the first ratio, the second ratio, and the third ratio according to a comparison result, so as to update the predicted channel information.

10. The channel selection method of claim 9, further comprising:
receiving at least one communication state of at least one unlicensed frequency band, so as to obtain the first communication data, the second communication data, and the third communication data.

11. The channel selection method of claim 9, further comprising:
calculating a number of at least one time unit in which a specific signal is transmitted through at least one unlicensed frequency band.

12. The channel selection method of claim 9, wherein the second communication data and the third communication data are transmitted through an unlicensed frequency band at the same time point, wherein the second communication data and the third communication data comprise a first signal strength of a first signal and a second signal strength of a second signal, respectively, and the processor predicts a signal strength data according to the first signal strength and the second signal strength,
wherein the channel changing data comprises the signal strength data.

13. The channel selection method of claim 9, further comprising:
receiving a plurality of signal strength data sequentially, and predicting a channel occupation data according to at least one overlapping portion among the signal strength data,
wherein the time duration data comprises the channel occupation data.

14. The channel selection method of claim 13, wherein when the third ratio is greater than the first ratio and the second ratio, the second ratio is greater than the first ratio, and the channel occupation is determined as unpredictable, adding the value of the third ratio to the value of the second ratio and updating the value of the third ratio to zero.

15. The channel selection method of claim 12, wherein when the second ratio is greater than the first ratio and the third ratio, the first ratio is greater than the third ratio, and the signal strength data is determined as unpredictable, adding the value of the second ratio to the value of the first ratio and updating the value of the second ratio to zero.

16. The channel selection method of claim 9, after updating the predicted channel information, further comprising:
establishing a communication link according to the predicted channel information.
